(19) United States
(12) Patent Application Publication
(10) Pub. No.: US 2018/0129325 A1
(43) Pub. Date: May 10, 2018

(54) Credit Navigation System and Method

(71) Applicant: Mark Shreve, Townsend, DE (US)

(72) Inventor: Mark Shreve, Townsend, DE (US)

(73) Assignee: JPMorgan Chase Bank, N.A.

(21) Appl. No.: 12/013,568

(22) Filed: Jan. 14, 2008

(51) Int. Cl. G06F 3/048

(52) U.S. Cl. CPC G06F 3/048

(57) ABSTRACT

A credit navigation system is provided for navigating through functions implemented by a credit decision engine. The credit navigation system comprises a decision navigation engine, the decision navigation engine implementing a main navigator module for displaying a credit decision navigator window. The credit decision navigator window may include a credit navigator tree viewer for displaying selectable nodes related to at least one selected segment and at least one selected inbound event, wherein the nodes include decision functions performed for the at least one selected segment and the at least one selected inbound event. The credit decision navigator window may further include at least one viewing pane for viewing parameters related to a selected node on the credit navigator tree viewer.

### TECHNICAL FIELD

Embodiments of the invention are related generally to systems and methods for displaying and manipulating decision data and in particular to systems and methods for displaying and manipulating decision trees, matrices, and other functions implemented in making credit-related decisions in order to obtain a comprehensive view of the decision-making process.

### BACKGROUND OF THE INVENTION

Decision management systems are often implemented by various institutions to make a determination of creditworthiness. These institutions typically include financial institutions, but may also include utility companies, merchants, mortgage brokers, etc. The institutions receive credit applications and process them through decision management systems to seek a determination as to the creditworthiness of the applicants.

Some examples of known decision management systems are those produced by CGI Group Inc. An integrated set of products including an Automated Credit Application Processing System (ACAPS®) and Strata® controls decision management and offers businesses the opportunity to evolve their credit policies. ACAPS® implements data from multiple sources for analysis and provides responses to credit requests over preferred customer channels, such as bank branches, telephone, and Internet. Strata® may be linked with ACAPS® and may offer a business user interface so that business users can integrate business rules for approving credit card applications. Strata® is an enterprise-wide, customer-based business rules engine that enables organizations to create, execute, measure, and experiment with various customer decision strategies. Strata® and other decision management systems typically segment customers according to various criteria such as credit risk, customer value, or vulnerability. Customer decision strategies for various segments are implemented to support functions such as marketing, credit originations, customer servicing, and collections. The use of such automated decision management systems typically reduces credit application turnaround time by automating processing steps such as calculation of credit scores, interpretation of bureau reports, and preparation of reports.

The decision management system may automate credit processes from application capture through fulfillment. The decision management system may monitor and evaluate data from a plurality of sources. Based on the collected data, the decision management system may implement such tools as scoring models, segmentation, decision trees, and matrices. For example, when evaluating a credit card application, business rules for that application are implemented to determine whether to approve the application. The business rules may evaluate a credit card application by passing credit card scores through a decision tree. The nodes of the tree may encapsulate credit score ranges. For example, one node may include a 400-500 score and if the score falls in that range, the application is declined. If the score is in the 501-600 range of the next node, then the application may be approved. The approval path may further extend through additional nodes and branches to determine credit line to ultimately result in a waterfall of decision trees.

While some decision management systems offer users a graphic user interface (GUI) to develop decision strategies and business rules, most available GUIs have limited scope and enable business users to view only one decision tree or rules at one time and no sub-trees. Thus, when a business user finds that too many applications are being rejected, the business user is required to use to view rules and decisions one-by-one in order to find the source of the excessive rejection rate.

For example, in existing systems, when a business user wants to locate decision trees, each decision tree could end in a link to another such that an extensive waterfall of decision trees is created. In currently existing decision management GUIs, only one tree at a time can be viewed. Thus for the business analyst or tester, moving through the decision trees is very difficult and time consuming.

Furthermore, from a documentation perspective, upon creating business rules, business users want to create documentation that testers and others can use to test and analyze the system. Currently existing systems are unable to accomplish this without creating a giant bulk of individual sheets. Thus, decision management systems can be difficult for business users to test and analyze due to the large volume of documentation associated with the systems and the difficulty of using the typical GUI to view this documentation. For example, computer diagrams such as Visio® diagrams, which display the flow of decision trees and attribute trees are often implemented. Additionally, spreadsheets, such as Microsoft Excel® documents are available to display Boolean and computed definitions. While the drawings and spreadsheets are helpful for auditing purposes, they provide an inefficient platform for testers and analysts.

Thus, a solution is needed that provides an easily accessible display of decision trees, attribute trees, Booleans, computed, matrices, externals, and outbound event lists in a visual and interactive format. Additionally, a solution is needed that enables interactive viewing of multiple business rules at one time. The solution should allow for a complete top down view of business rules in the decision management system. Furthermore, a solution is needed that provides a facility to view attribute definitions directly from decision or attribute tree views.

### BRIEF SUMMARY OF THE INVENTION

In one aspect of the invention, a credit navigation system is provided for navigating through functions implemented by a credit decision engine. The credit navigation system comprises a decision navigation engine that implements a main navigator module for displaying a credit decision navigator window. The credit decision navigator window comprises a credit navigator tree viewer for displaying selectable nodes related to at least one selected segment and at least one selected inbound event, wherein the nodes include decision functions performed for the at least one selected segment and the at least one selected inbound event. The credit decision navigator window additionally includes at least one viewing pane for viewing parameters related to a selected node on the credit navigator tree viewer.

In an additional aspect of the invention, a decisioning computing system is provided for executing and reviewing credit-related decisions. The decisioning computing engine may include decision engine for making credit related decisions based on business rules and available data and a credit decision navigation engine for facilitating viewing of the credit related decisions. The credit decision navigation engine comprises a credit navigator tree viewer for displaying selectable nodes related to at least one selected segment and at least one selected inbound event, wherein the nodes include decision functions performed for the at least one selected segment and the at least one selected inbound event.

In yet an additional aspect of the invention, a method for managing credit related decisions reached through the use of a decision engine is provided. The decision engine may implement businesses rules and available data to arrive at the credit related decisions. The method includes viewing the credit related decisions through implementation of a credit decision navigation engine for facilitating viewing of the credit related decisions. The credit decision navigation engine includes a credit navigator tree viewer for displaying selectable nodes related to at least one selected segment and at least one selected inbound event, wherein the selectable nodes include decision functions performed for the at least one selected segment and the at least one selected inbound event to arrive at the credit related decisions. The method additionally includes selecting a selectable node from the credit navigator tree viewer and viewing additional data related to the selectable node.

### BRIEF DESCRIPTION OF THE DRAWINGS

The present invention is described in detail below with reference to the attached drawings figures, wherein:

FIG. 1 is a block diagram illustrating an operating environment for a decisioning computing system in accordance with an embodiment of the invention;

FIG. 2 is a block diagram illustrating a decision navigation engine in accordance with an embodiment of the invention;

FIG. 3A is a screen shot illustrating a credit decision navigator window in accordance with an embodiment of the invention;

FIG. 3B is a screen shot illustrating a populated credit decision navigator window in accordance with an embodiment of the invention;

FIG. 3C is a screen shot illustrating a populated tree path window within the credit decision navigator window in accordance with an embodiment of the invention;

FIG. 3D is a screen shot illustrating a selected decision tree utilization window within the credit decision navigator window in accordance with an embodiment of the invention;

FIG. 3E is a screen shot illustrating a selected attribute tree utilization window within the credit decision navigator in accordance with an embodiment of the invention;

FIG. 4 illustrates a tool bar of the credit decision navigator window in accordance with an embodiment of the invention;

FIG. 5A is a screen shot illustrating a credit decision navigator menu in accordance with an embodiment of the invention;

FIG. 5B is a screen shot illustrating another view of the credit decision navigator menu in accordance with an embodiment of the invention;

FIG. 5C is a screen shot illustrating another view of the credit decision navigator menu in accordance with an embodiment of the invention;

FIG. 5D is a screen shot illustrating a pop-up window generated by the menu in accordance with an embodiment of the invention;

FIG. 5E is a screen shot illustrating another view of the credit decision navigator menu in accordance with an embodiment of the invention;

FIG. 5F illustrates a legend illustrates a popup window generated by the menu in accordance with an embodiment of the invention;

FIG. 6 is a screen shot illustrating a decision tree explorer window in accordance with an embodiment of the invention;

FIG. 7 is a screen shot illustrating a tool bar of the decision tree explorer window in accordance with an embodiment of the invention;

FIG. 8 is a screen shot illustrating a decision tree explorer search results window in accordance with an embodiment of the invention;

FIG. 9A is a screen shot illustrating an attribute tree explorer window in accordance with an embodiment of the invention;

FIG. 9B is a screen shot illustrating a toolbar in accordance with an embodiment of the invention;

FIG. 10 is a screen shot illustrating a Boolean explorer window in accordance with an embodiment of the invention;

FIG. 11 is a screen shot illustrating a computed explorer window in accordance with an embodiment of the invention;

FIG. 12A is a screen shot illustrating an external attribute explorer window in accordance with an embodiment of the invention;

FIG. 12B is a screen shot illustrating a process of exporting attribute data in accordance with an embodiment of the invention;

FIG. 13 is a screen shot illustrating a matrix explorer window in accordance with an embodiment of the invention;

FIG. 14 is a screen shot illustrating an outbound event explorer window in accordance with an embodiment of the invention;

FIG. 15 is a screen shot illustrating a text search window in accordance with an embodiment of the invention;

FIG. 16 is a screen shot illustrating a bookmarks window in accordance with an embodiment of the invention;

FIG. 17A is a screen shot illustrating a simulation results viewer in accordance with an embodiment of the invention;

FIG. 17B is a screen shot illustrating a test scenario menu from the simulation results viewer in accordance with an embodiment of the invention;

FIG. 17C is a screen shot illustrating a simulation results viewer in accordance with an embodiment of the invention;

FIG. 17D is a screen shot illustrating another view of a simulation results viewer in accordance with an embodiment of the invention;

FIG. 18A is a screen shot illustrating a nested attribute window in accordance with an embodiment of the invention;

FIG. 18B is a screen shot illustrating export of the nested attribute list in accordance with an embodiment of the invention

FIG. 18C is a screen shot illustrating export of a random number list in accordance with an embodiment of the invention;

FIG. 19 is a screen shot illustrating credit decision navigator version changes in accordance with an embodiment of the invention; and

FIG. 20 is a flow chart illustrating a method of implementing a decisioning computing system in accordance with an embodiment of the invention.

### DETAILED DESCRIPTION OF PREFERRED EMBODIMENTS

Embodiments of the present invention are directed to a credit navigation system and method. The method and system allow for viewing of decision trees and criteria implemented to make decisions in a straightforward manner. The system provides an easily accessible display of decision trees, attribute trees, Booleans, computed (calculated value), matrices, externals, and outbound event lists in a visual and interactive format. Additionally, the solution enables interactive viewing of multiple business rules at one time.

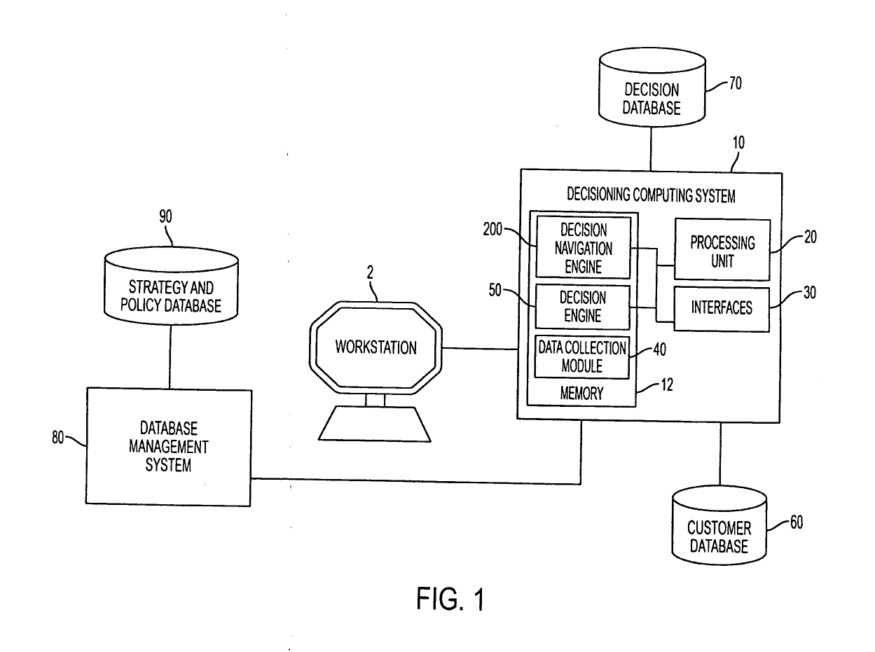

FIG. 1 is a block diagram illustrating an operating environment for a credit navigation system in accordance with an embodiment of the invention. A workstation 2 enables access to viewing, testing, simulation manipulation etc., of a decisioning computing system 10. The decisioning computing system 10 may include a memory 12. The memory 12 preferably includes a data collection module 40, a decision engine 50, and a decision navigation engine 200. These components stored in the memory 12 may be executed implementing a processing unit 20 and may communicate with the workstation 2 and other components through interfaces 30.

The decision engine 50 may be an engine known in the art, such as those described in the background of the invention system. The decision engine 50 implements functions such as decision trees and matrices to operate on client segments and arrive at decisions.

The decisioning computing system 10 may be linked to databases, such as a customer database 60 and a decision database 70. The decisioning computing system 10 may further be linked with a database management system 80 and a strategy and policy database 90. The databases may be configured for Online Analytical Processing, or OLAP in order to quickly provide answers to analytical queries that are multidimensional in nature. The output of an OLAP query is typically displayed in a matrix format. The dimensions form the row and column of the matrix.

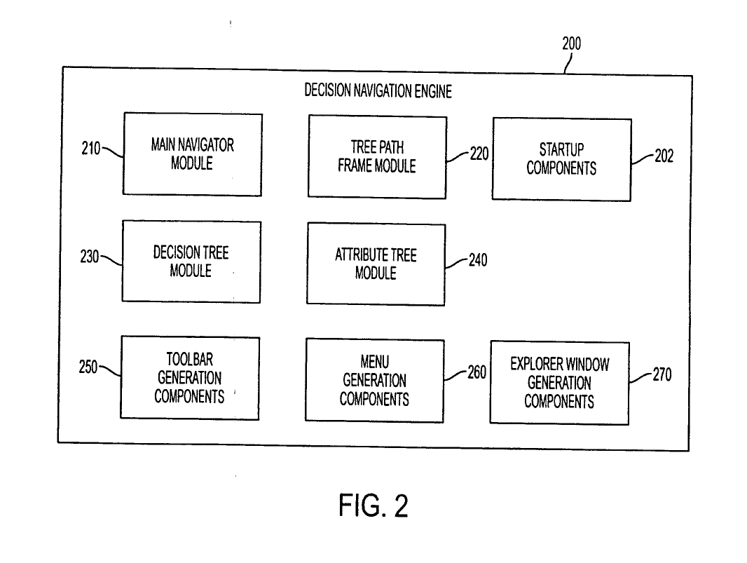

FIG. 2 illustrates details of the decision navigation engine 200 in accordance with embodiments of the invention. The decision navigation engine 200 may include startup components 202, a main navigator module 210, a tree path frame module 220, a decision tree module 230, and an attribute tree module 240. The decision navigation engine 200 may additionally include toolbar generation components 250, menu generation components 260, and explorer window generation components 270. Each of these components will be further described below with relation to their functions.

All of the components shown in FIG. 1 and FIG. 2 below may be, include, or be implemented by a computer or multiple computers. The components may be described in the general context of computer-executable instructions, such as program modules, being executed by a computer. Generally, program modules include routines, programs, objects, components, data structures, etc. that performs particular tasks or implement particular abstract data types.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system of platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. The authentication system 200 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

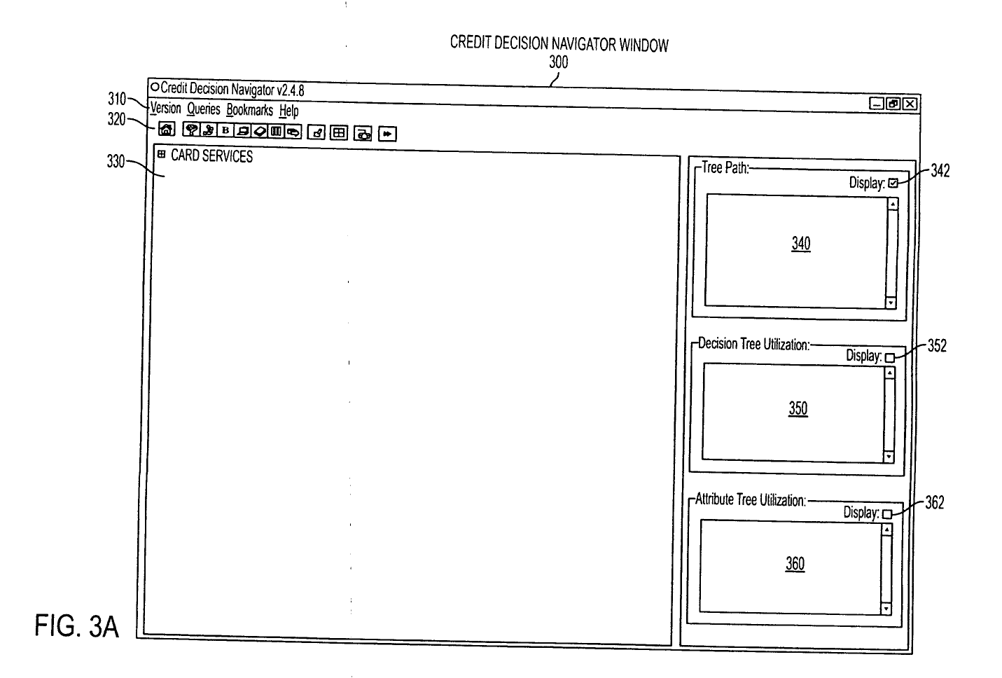

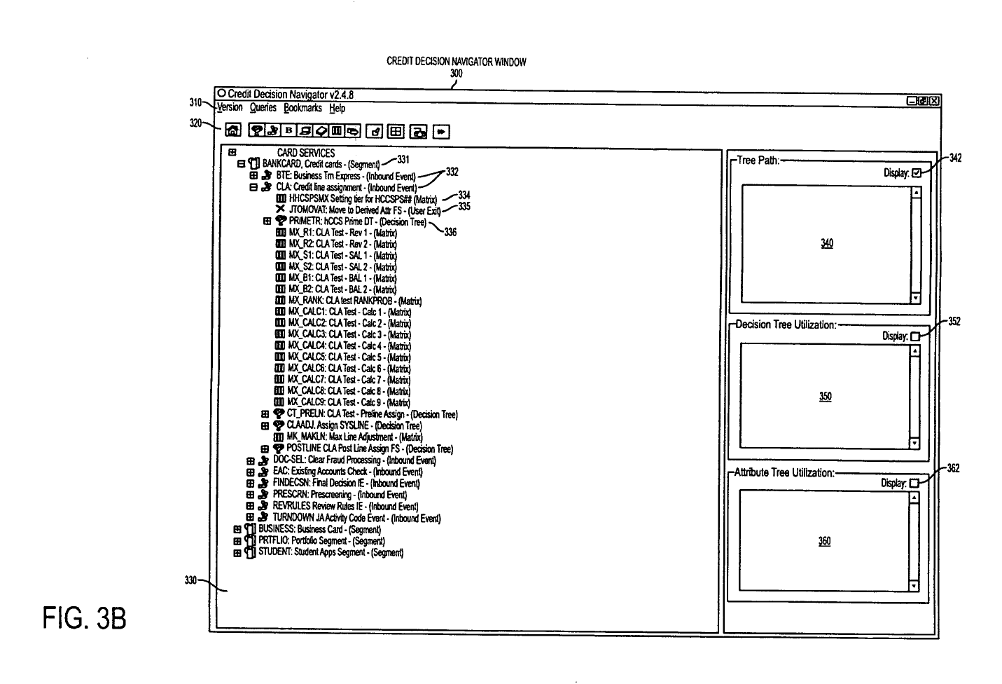

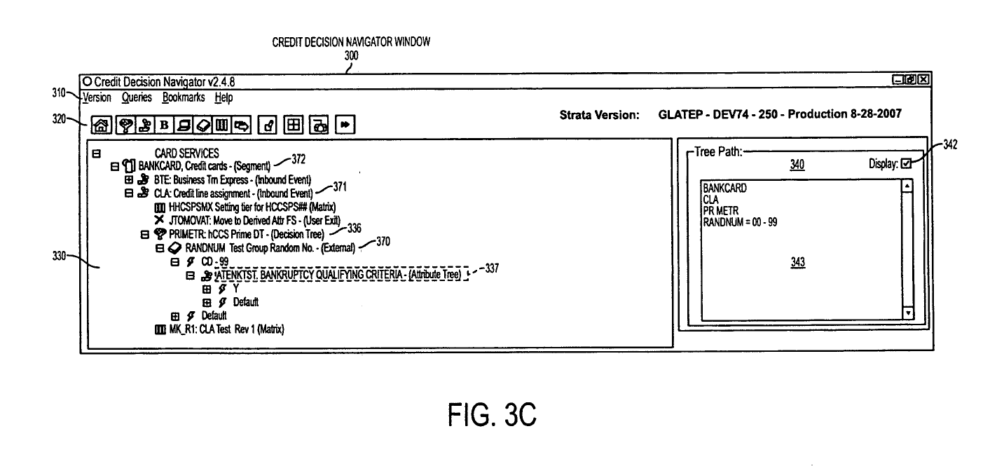

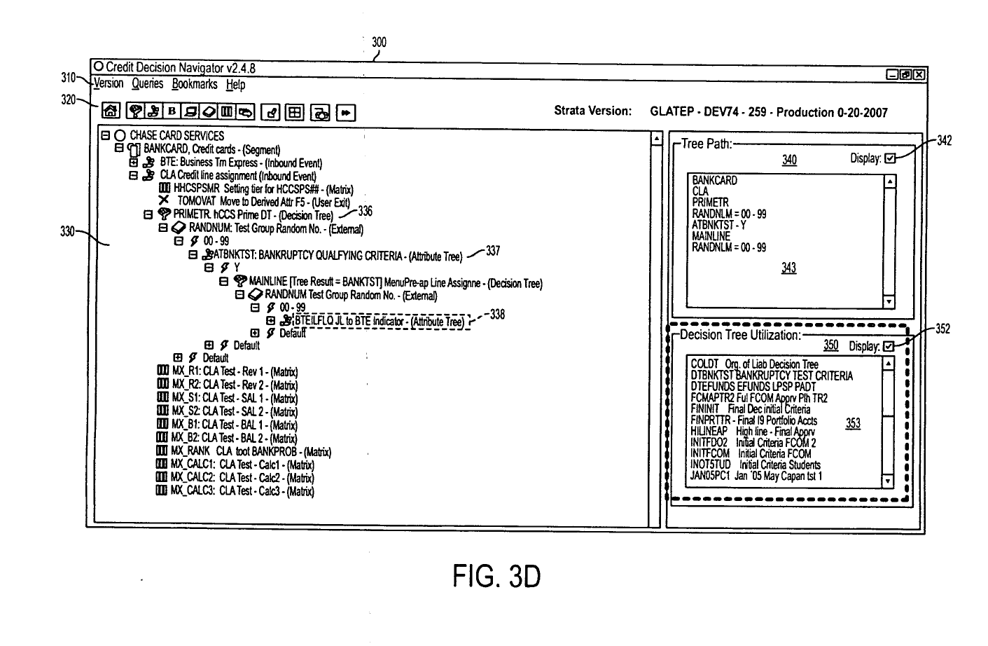

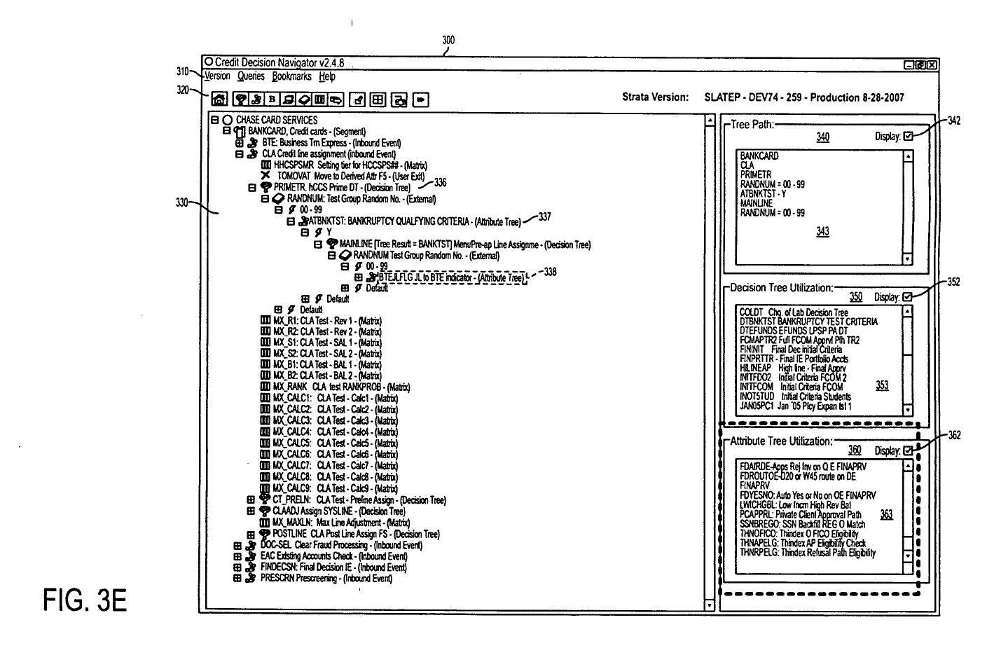

FIG. 3A is a screen shot illustrating a credit decision navigator window 300 in accordance with an embodiment of the invention. Once the decision navigation engine 200 is loaded in a computerized environment, the credit decision navigator window 300 is loaded and controlled by the main navigator module 210 described above with respect to FIG. 2. The credit decision navigator window 300 may include a menu 310, a toolbar 320, and a credit decision navigator tree viewer 330. The credit decision navigator window 300 may additionally include a tree path viewing pane 340, a decision tree utilization viewing pane 350, and an attribute tree utilization pane 360. Each of these panes 340, 350, and 360 may include a respective display checkbox 342, 352, and 362. When checked, the boxes 342, 352, and 362 ensure that the tree path viewing pane 340, the decision tree utilization viewing pane 350, and the attribute tree utilization pane 360 are displayed on the credit decision navigator window 300. When the boxes 342, 352, and 362 are left unchecked, the panes 340, 350, and 360 are not displayed.

FIG. 3B is a screen shot illustrating a populated credit decision navigator tree viewer 330 in accordance with an embodiment of the invention. The credit decision navigator tree viewer 330 allows user to interactively move through decision trees provided by the decision engine. Users may interactively move through the decision trees based upon selection of a segment, such as 331, or an inbound event 332. Functions such as matrix 334, user exit 335, and decision tree 336 exist within the bankcard segment 331 under the credit line assignment inbound event 332. As illustrated, multiple matrices and decision trees may correspond to a segment and inbound event. The illustrated viewer 330 shows all functions, including matrices and decision trees, that exist within the bankcard segment 331 for a CLA inbound event 332.

In the context of the system of the invention, an “inbound event” may be defined as a trigger received from an external system to indicate occurrence of a client event. A client may be a customer, an account, an applicant, etc. Each client may possess associated “attributes” such as client age and client balance. An attribute is a data element passed into the decisioning computing system from an external source or alternatively, may be a data element derived by the decisioning computing system through evaluation and processing. A “segment” in the context of the invention may include a set of clients grouped according to a characteristic by which the clients will be separated for evaluation. Thus for each segment, a unique set of evaluation criteria may be applied. Additional terminology implemented herein may include “functions” such as a “matrix” or a “decision tree”, which are well known decision-making functions.

FIG. 3C is a screen shot illustrating a populated tree path frame 340 generated by the tree path frame module 220 as described above with reference to FIG. 2. within the credit decision navigator window in accordance with an embodiment of the invention. The tree path frame 340 displays a full path 343 of a selected node 337 in the credit decision navigator tree viewer 330. The tree path 343 shows that the selected node is a member of the RANDNUM test group 370 under the PRIMETR decision tree 336, the CLA inbound event 371, and the bankcard segment 372. The selected node 337 is a node of the decision tree 336. In order to display the path, the display box 342 must be checked. Showing the path 343 may slow the operation of the credit decision navigator tree viewer 330 and therefore, if the path 343 does not need to be viewed, a user may unselect the box 342 to enhance operation.

FIG. 3D is a screen shot illustrating a selected decision tree utilization frame 350 within the credit decision navigator window 300 in accordance with an embodiment of the invention. The decision tree utilization frame 350 displays a list of all decision trees 353 that utilize a selected node 338 in the credit decision navigator tree viewer 330. In the illustrated example, the selected node 338 is an attribute tree under the decision tree 336 and attribute tree 337. Selecting the display checkbox 352 causes the decision trees to be displayed and un-checking the display box 352 eliminates the display of decision trees in the decision tree utilization frame 350.

FIG. 3E is a screen shot illustrating a selected attribute tree utilization frame 360 within the credit decision navigator window 300 in accordance with an embodiment of the invention. The attribute tree utilization frame 360 displays a list 363 of all attribute trees that use the selected node 338 in the credit decision navigator tree viewer 330. As with the viewing frames above, the list 363 is displayed when the checkbox 362 is checked.

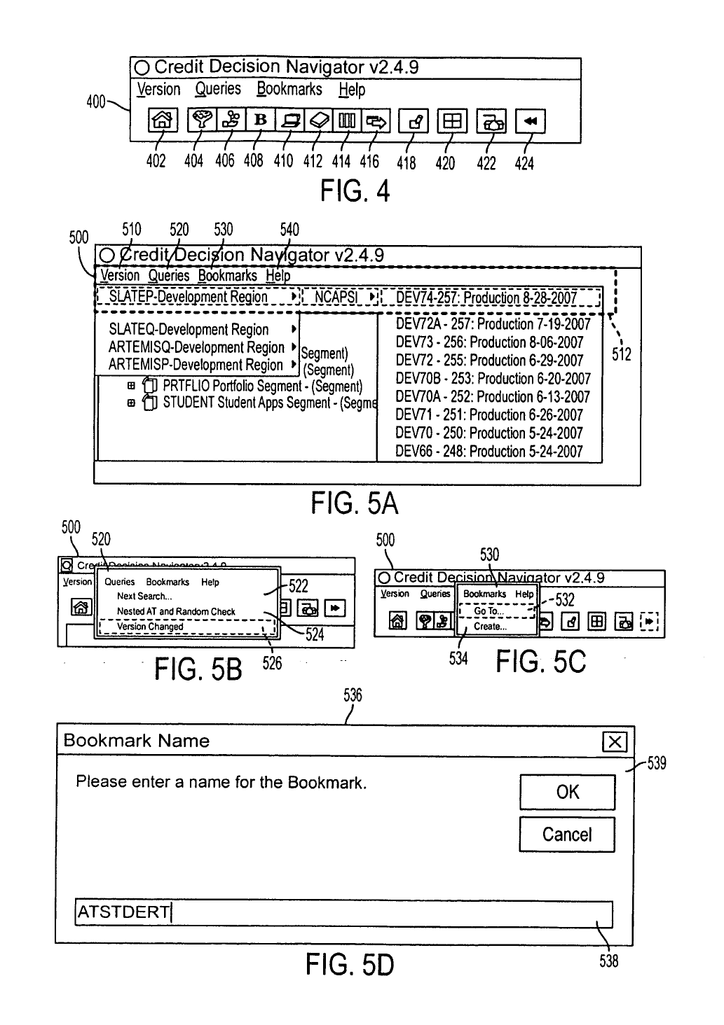

FIG. 4 illustrates a tool bar 400 of the credit decision navigator window 300 that may be generated by the toolbar generation component 250 in accordance with an embodiment of the invention. The toolbar 400 may include a home button 402, a decision tree explorer button 404, an attribute tree explorer button 406, a Boolean explorer button 408, a computed explorer button 410, an external attribute explorer button 412, a matrix explorer button 414, an outbound event list explorer button 416, a bookmark explorer button 418, a legend button 420, a simulation results button 422, and a hide/show right window pane button 424.

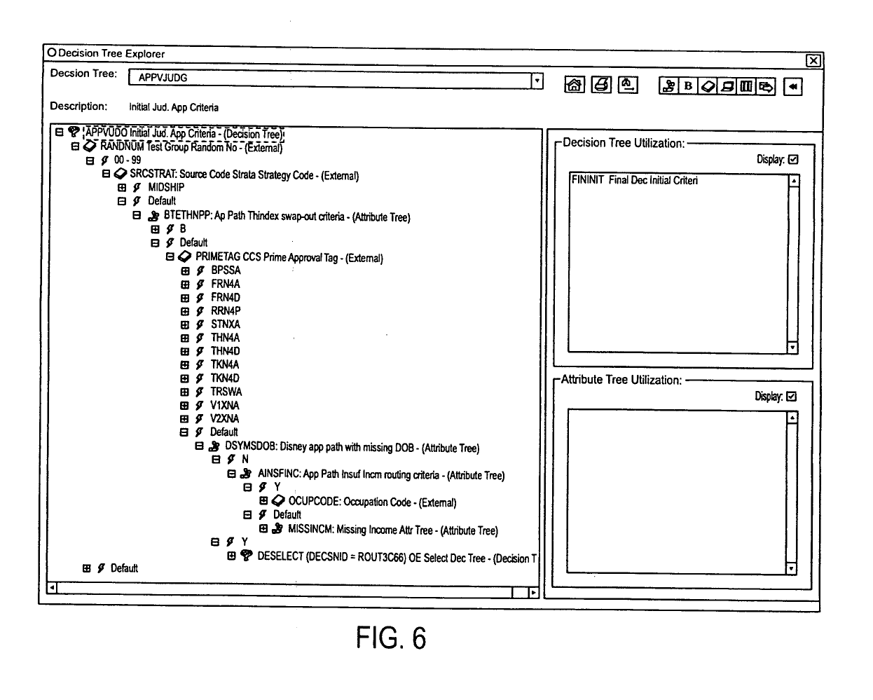

The home button 402, when selected, will collapse all expanded nodes in the credit decision tree navigator viewer 330. The decision tree explorer button 404 may open a decision tree explorer window through implementation of the decision tree module 230 of FIG. 2, allowing users to view specific decision trees without the requirement to view parent trees such as inbound event, segment or parent decision trees. This will be further discussed in detail below with reference to FIG. 6-8.

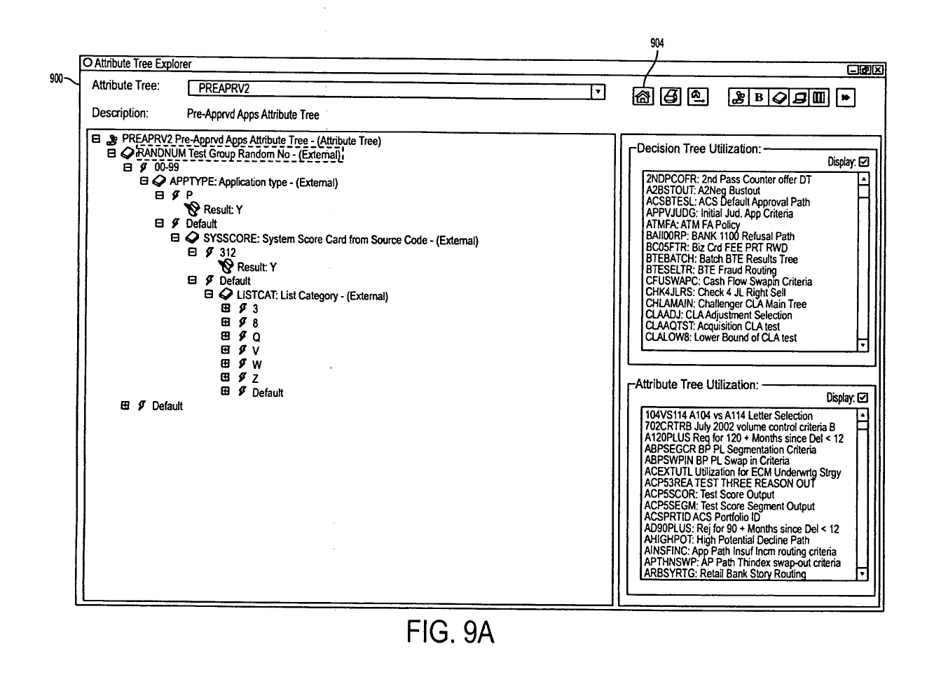

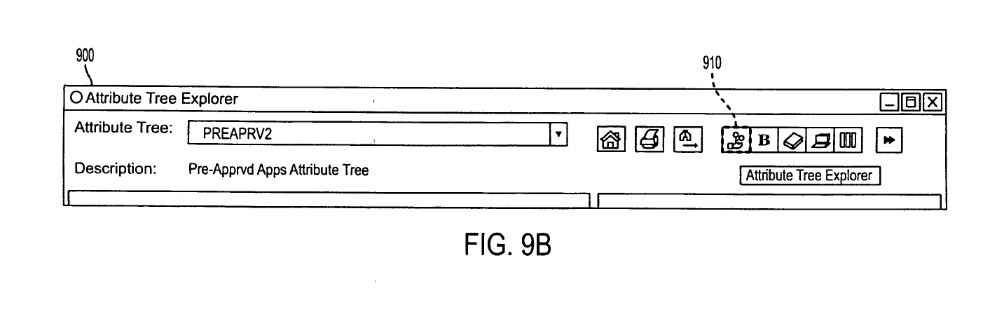

The attribute tree explorer button 406 may open an attribute tree explorer window through implementation of the attribute tree module 240 described above with reference to FIG. 2, allowing users to view specific attribute details without the requirement to view a parent inbound event, segment, or parent decision trees. The attribute tree explorer button 406 will be further described below with reference to FIGS. 9A and 9B.

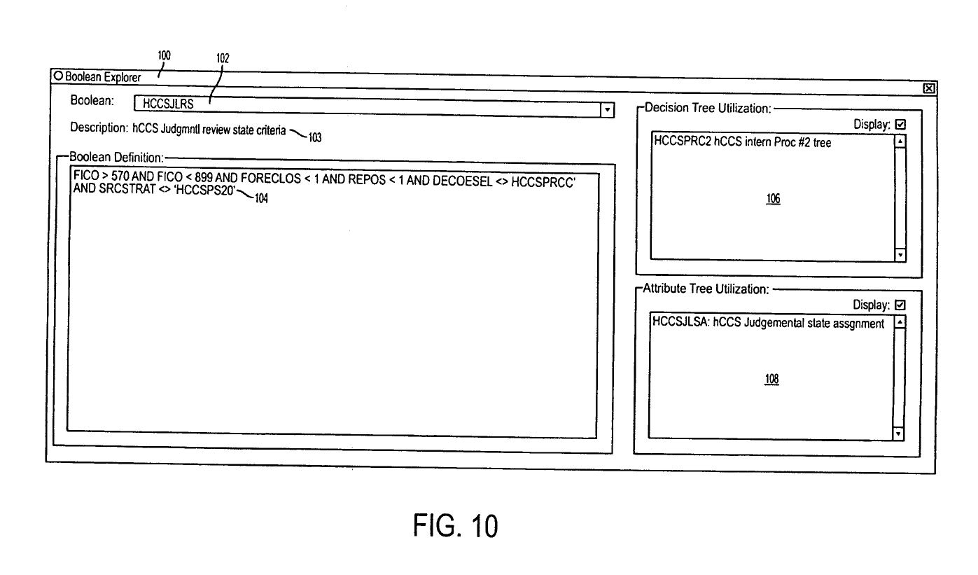

The Boolean explorer button 408 may open a Boolean explorer window through implementation of the explorer window generation component 270 of FIG. 2, allow viewers to view specific Boolean attribute details, without the requirement to view parent inbound event, segment, or parent decision trees. The Boolean explorer button will be further described below with reference to FIG. 10.

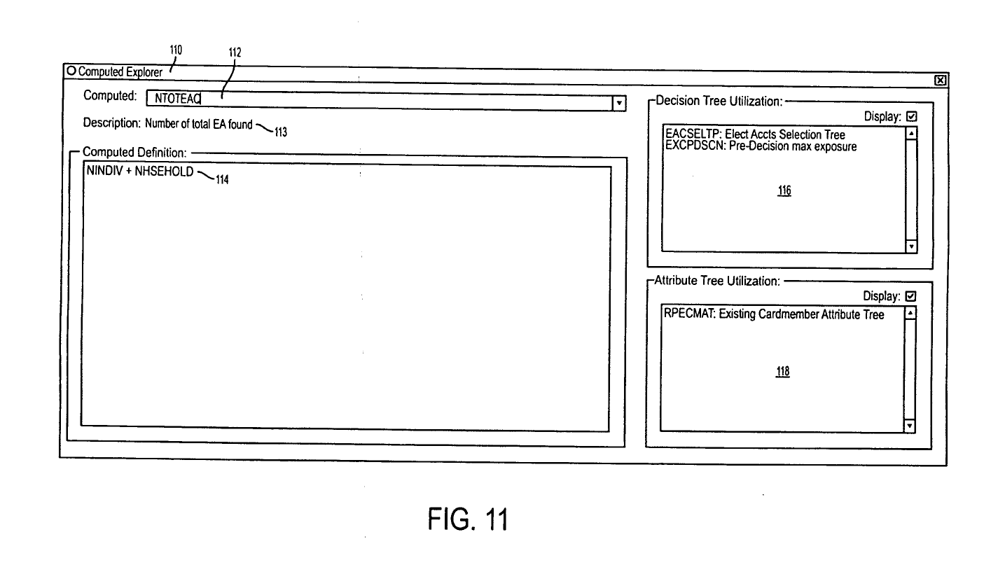

The computed explorer button 410 may open a computed explorer window, allowing users to view specific computed attribute details without the requirement to view a parent inbound event, segment, or parent decision tree, or parent attribute tree. The computed explorer button 410 will be further described below with reference to FIG. 11.

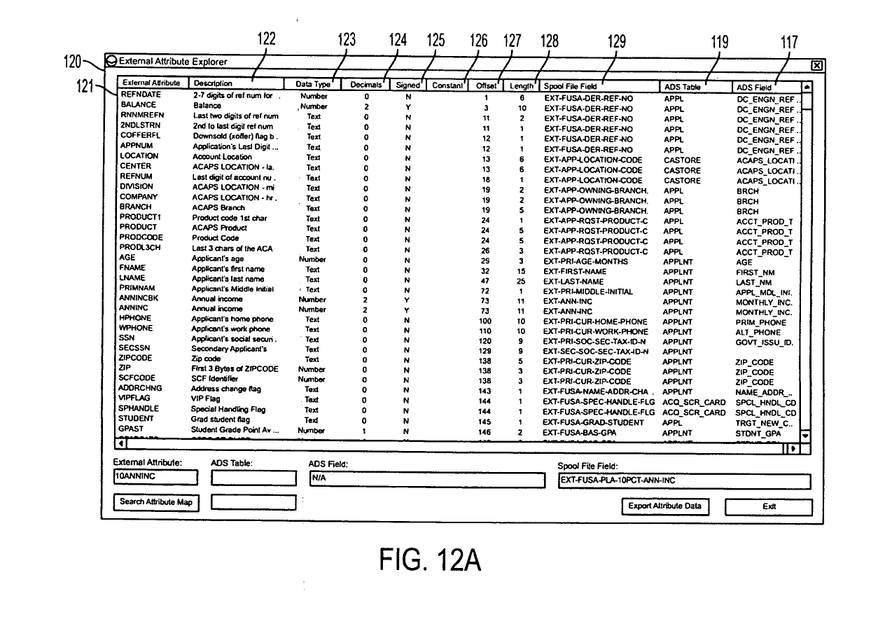

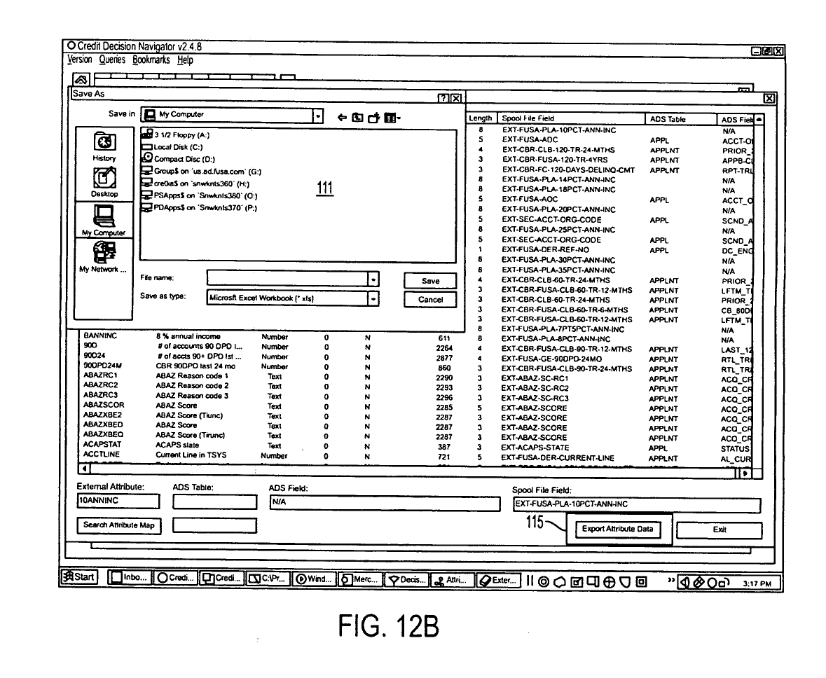

The external attribute explorer button 412 may open an external attribute explorer window, through implementation of the explorer window generation components 270 of FIG. 2., allowing users to view specific external attribute details, without the necessity for viewing parent inbound event, segment, and parent decision trees and parent attribute trees. This will be discussed further below with reference to FIGS. 12A and 12B.

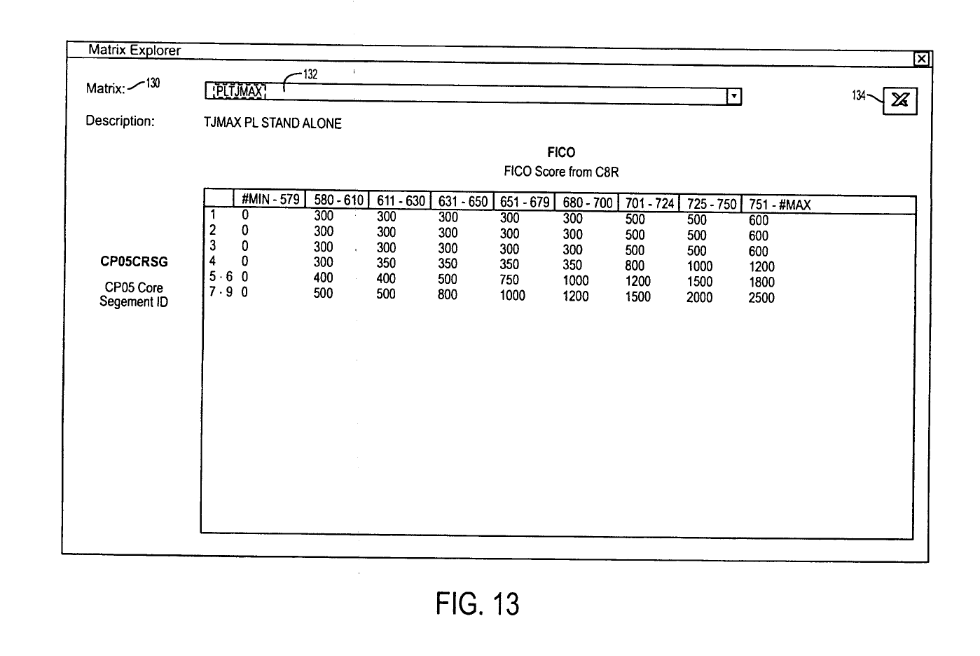

The matrix explorer button 414 may open a matrix explorer window, through implementation of the explorer window generation components 270 of FIG. 2., which will be further described below with reference to FIG. 13. The matrix explorer window may allow users to view specific details without the necessity for viewing parent inbound events and segments, parent decision trees, and parent attribute trees.

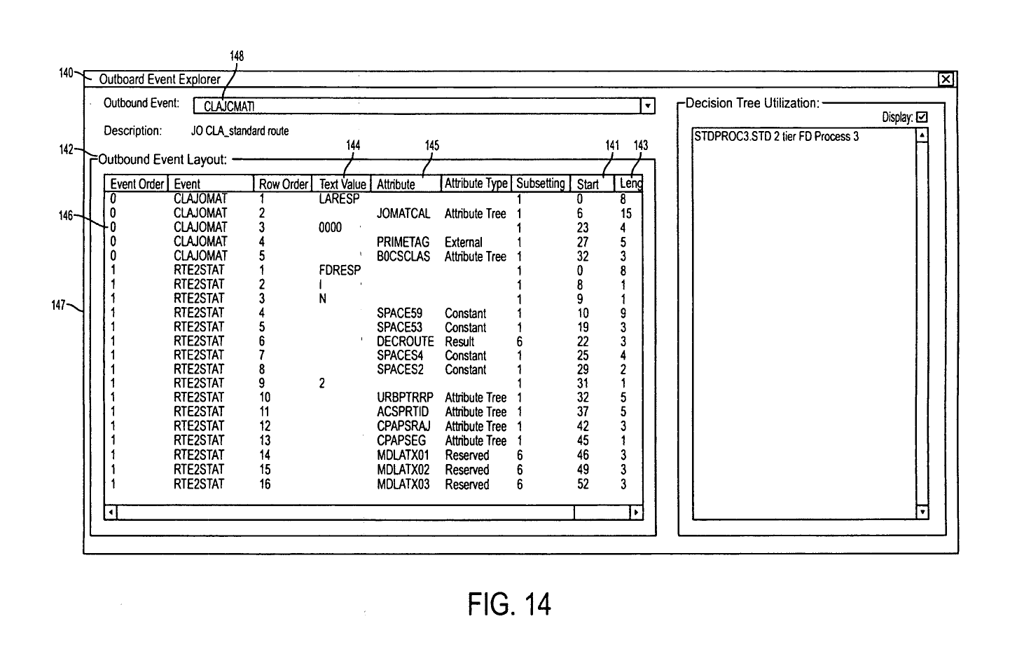

The outbound event list explorer button 416 may open an outbound event list window, through implementation of the explorer window generation components 270 of FIG. 2., which will be discussed in greater detail below with reference to FIG. 14. The outbound event list explorer button 416 may allow users to view specific outbound event list details, without the necessity for viewing parent inbound events and segments, parent decision trees, and parent attribute trees.

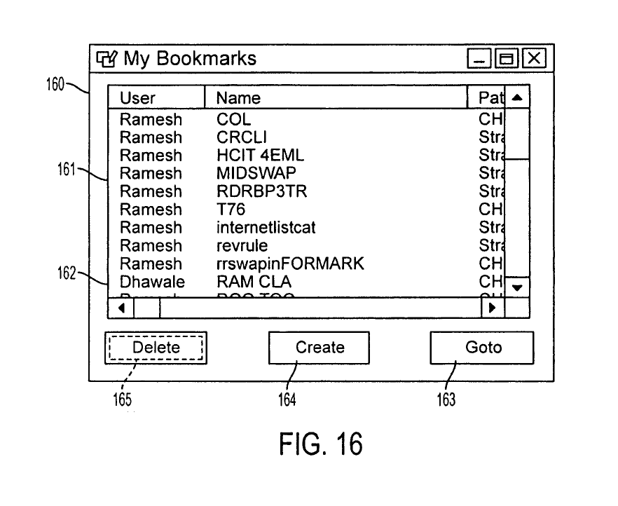

The bookmark explorer button 418 may open a bookmark explorer window, through implementation of the explorer window generation components 270 of FIG. 2, that will further be discussed below with reference to FIG. 16. The bookmark explorer button 418 may allow users to create or delete their own bookmarks or use any bookmarks created by the user.

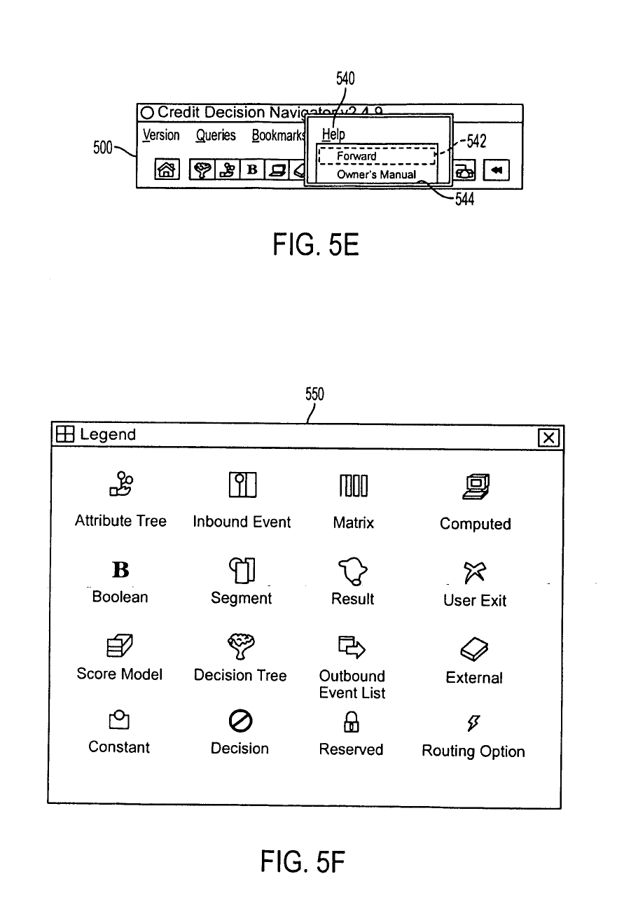

The legend button 420 may open a legend window through the menu generation components 260 of FIG. 2, which displays a list of each icon used in all of the application trees and corresponding descriptions. This will be further discussed below with reference to FIG. 5F.

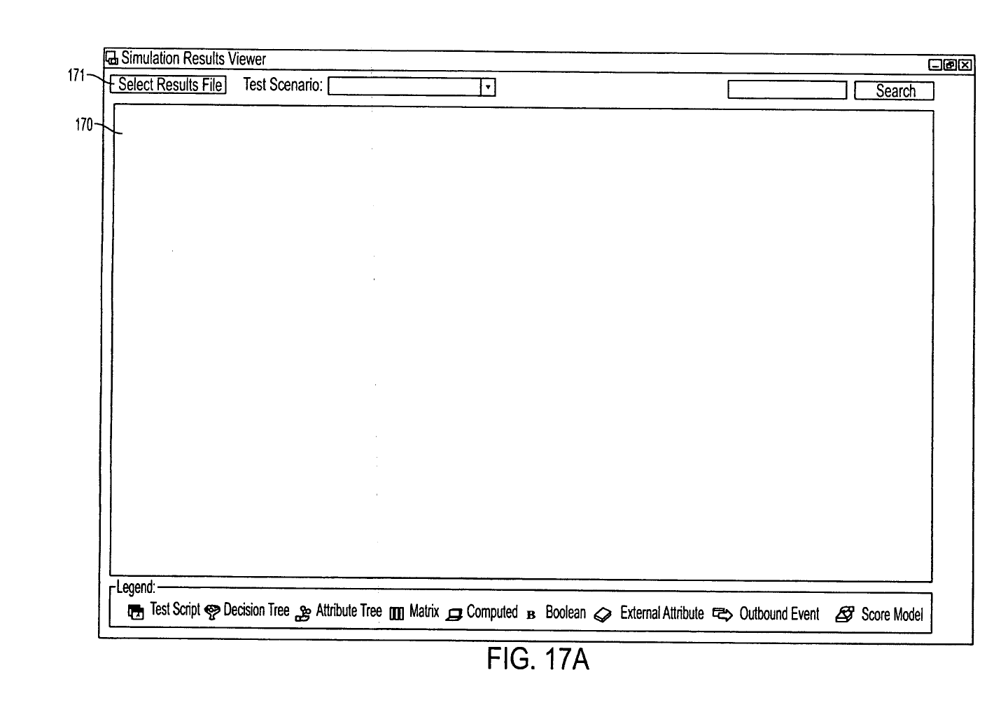

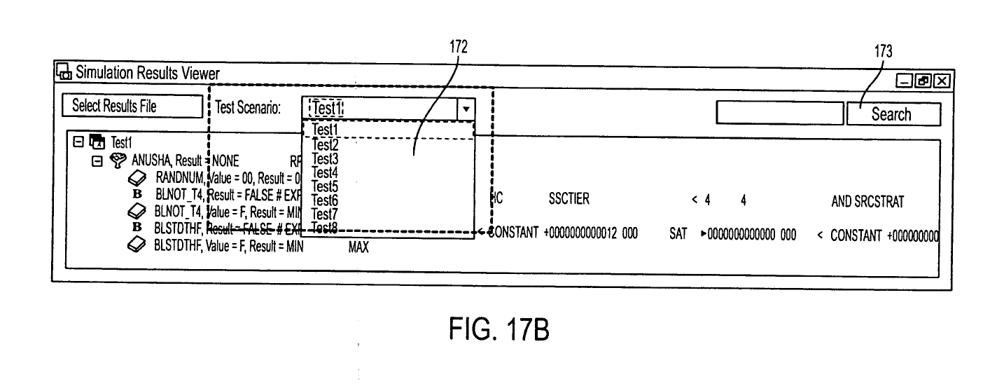

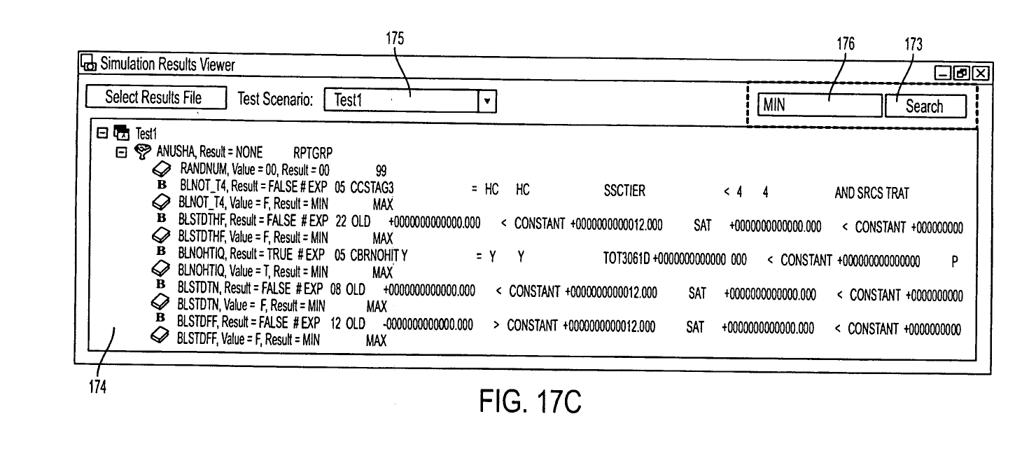

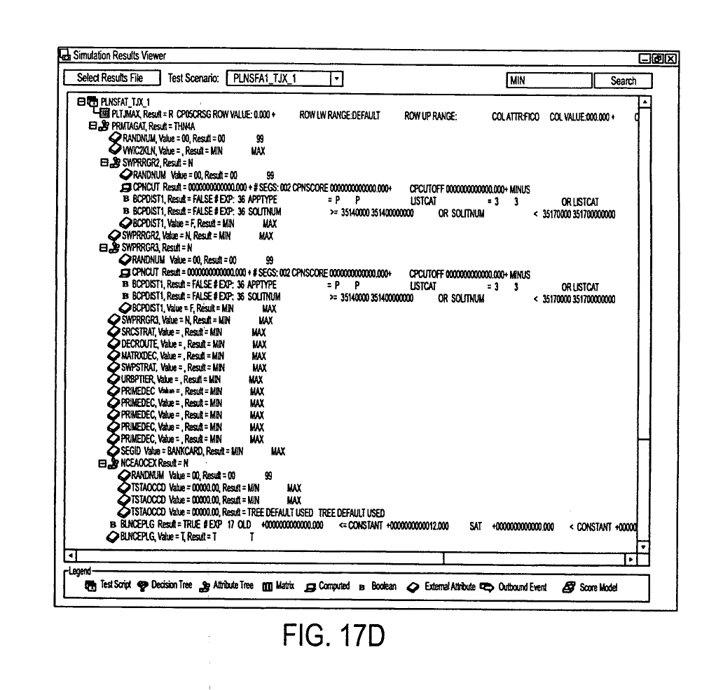

The simulation results button 422 may open a simulation results explorer window, through implementation of the explorer window generation components 270 of FIG. 2., further described below with reference to FIGS. 17A-17D. Selection of the simulation results button allows users to view details of simulation test in a visual interface.

The hide/show right window pane button 424 may hide or show the right side of the credit decision navigator window pane that displays the tree path, decision trees utilized, and attribute trees utilized.

FIG. 5A is a screen shot illustrating a credit decision navigator menu 500 in accordance with an embodiment of the invention. The menu 500 may include a selectable version option 510, a query option 520, a bookmark option 530, and help option 540. In FIG. 5A, the version option 510 has been selected and a drop down menu 512 with selectable options is displayed. The decision engine 50 may include multiple versions to handle such items as defect fixes and policy releases. When the decision navigation engine 200 is opened, a default version may open that is identical to the version the user last used. Users have the ability to change the decision engine version using the version menu option 540. After a version of the decision engine is selected, the decision navigation engine 200 is reloaded based on the selected version. The versions may for example differ for consumer cards and business cards.

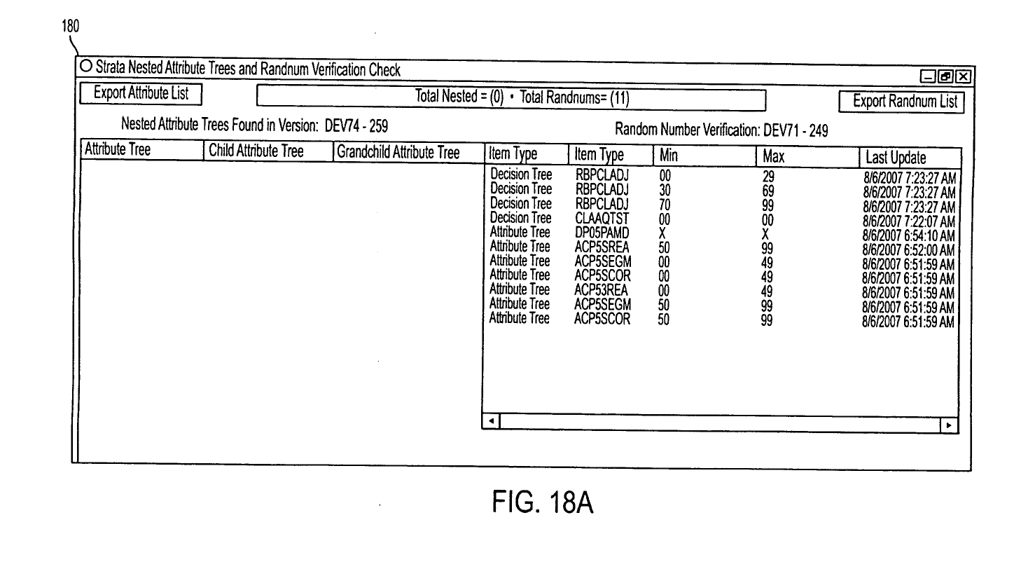

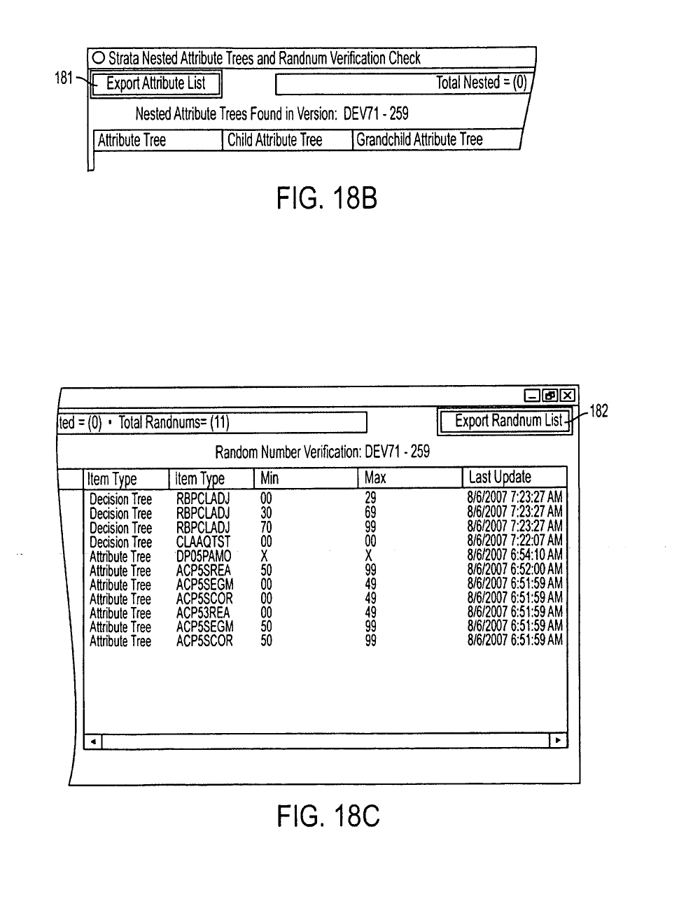

FIG. 5B is a screen shot illustrating another view of the credit decision navigator menu 500 in accordance with an embodiment of the invention in which the queries option 520 has been selected. Selecting the queries option 520 may provide a drop-down menu listing a text search option 522, a nested attribute tree and random number check 524, and a version changes 526 option. The text search option 522 allows a user to open a text search window. The nested attribute tree and random number option 524 allows a user to open a nested attribute tree and random number verification check window that will be described further below with reference to FIGS. 18A-C. The version changes option 526 may open a version change window which allows users to view the changes that have been made in each version of the decision engine 50.

FIG. 5C is a screen shot illustrating another view of the credit decision navigator menu 500 in accordance with an embodiment of the invention in which the bookmarks option 530 has been selected. The bookmarks option 530 may open a menu having a go to option 532 and a create option 534. The go to option 532 opens a bookmark window. The create option 534 allows creation of a bookmark. Bookmarks can be created by selecting a node on the credit decision navigator tree viewer 330 and then selecting bookmarks 530 from the menu 500 and create 534 from the dropdown list.

FIG. 5D is a screen shot illustrating a pop-up window 536 generated by the menu 500 when the create option 534 is selected from the bookmark option 530. The blank 538 allows a user to select a name for the bookmark. Once a bookmark is entered the user may select “OK” 539 to create the bookmark. The new bookmark will then appear in a bookmarks window and can be used at any time.

FIG. 5E is a screen shot illustrating another view of the credit decision navigator menu 500 in which a help option 540 has been selected in accordance with an embodiment of the invention. A drop down menu may include a legend option 542 and a user manual 544. Selecting the user manual 544 may open the latest version of the decisioning navigation system user manual.

FIG. 5F illustrates a legend window 550 that may open when the legend option 542 is selected. The legend window 550 lists each icon used with the credit decision navigator along with its corresponding description.

FIG. 6 is a screen shot illustrating a decision tree explorer window 600 in accordance with an embodiment of the invention as generated and controlled by the decision tree module 230 of FIG. 2. The decision tree explorer window allows users to view individual decision trees without having to view the full path based upon segments and inbound events. The decision tree explorer can be opened using two methods. The first method includes right clicking on a decision tree within the credit decision navigator tree viewer 330. The second method includes selected the decision tree explorer button on the credit decision navigator menu.

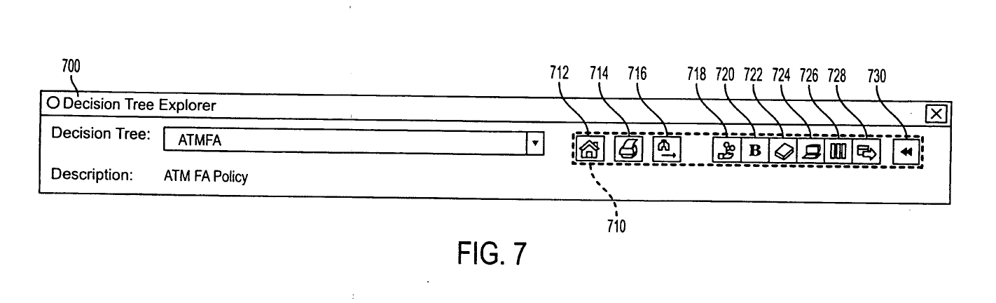

FIG. 7 is a screen shot 700 illustrating a tool bar 710 of the decision tree explorer window 600 in accordance with an embodiment of the invention. A home button 712 collapses all expanded nodes in the decision tree explorer window. A print tree button 714 expands all nodes within the selected decision tree excluding child decision trees and opens a print dialog which allows the user to print a selected tree.

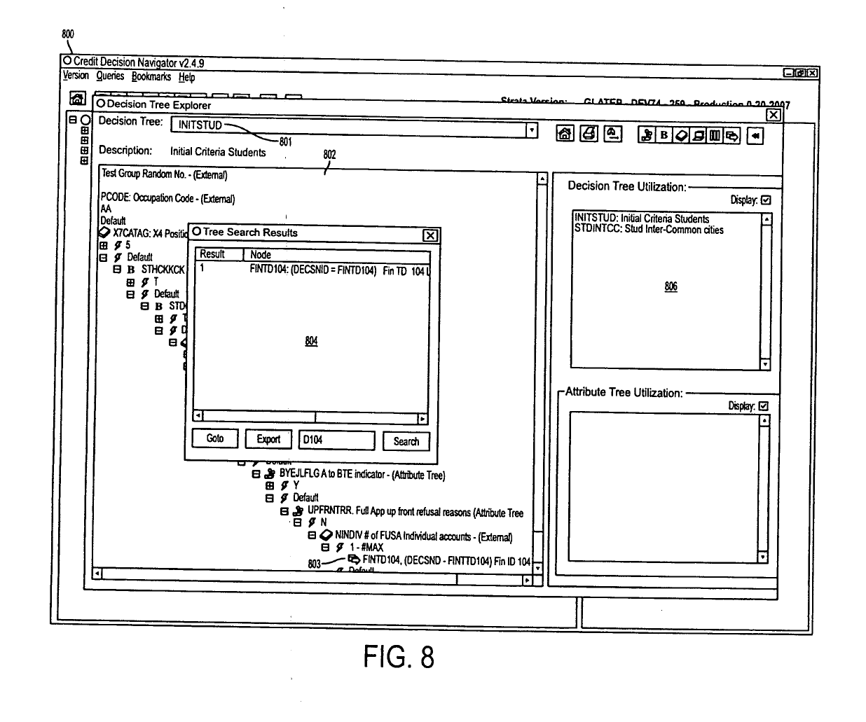

A search tree button 716 opens a tree search results window and is useful for searching a selected tree for any nodes that contain a specified text value. As illustrated with respect to FIG. 8, a screen shot 800 shows a text search of an INITSTUD decision tree 801 using text D104 at 803. The search returned one result listed in a tree search results window list 804. In embodiments of the invention, double clicking this entry in the list 804 will automatically display a node with the matching text value in a decision tree utilization window 806.

An attribute tree explorer button 718 opens an attribute tree explorer window. In embodiments of the invention, right clicking an attribute tree within the decision tree explorer window 600 can also access this window.

A Boolean explorer button 720 may open a Boolean explorer window. In embodiments of the invention, right-clicking a Boolean within the decision tree explorer window 600 can also access this window.

An external attribute explorer button 722 may open an external attribute explorer window. In embodiments of the invention, right-clicking an external attribute within the decision tree explorer window 600 can also access the external attribute explorer window.

A computed explorer button 724 may open a computed explorer window. In embodiments of the invention, right-clicking a computed within the decision tree explorer window 600 can also access the computed window.

A matrix explorer button 726 may open the matrix explorer window. In embodiments of the invention, right clicking a matrix within the decision tree explorer window 600 can also access this window.

An outbound event list explorer button 728 opens the outbound event list explorer window. In embodiments of the invention, right-clicking an outbound event list within the decision tree explorer window 600 can also access an outbound event list explorer window.

A show/hide right window pane explorer button 730 is capable of controlling the display of the right side window pane that shows the decision trees utilized and attribute trees utilized frames.

FIG. 9A is a screen shot illustrating an attribute tree explorer window 900 in accordance with an embodiment of the invention. The attribute tree explorer window 900 allows users to view attribute trees 902 without viewing a full bath based upon segments and inbound events. The attribute tree explorer window 900 can be opened by at least two methods including right clicking on the attribute tree within the credit decision navigator tree viewer 330 and clicking on the attribute tree explorer button on the toolbar of the credit decision navigator window 300. Most of the toolbar buttons 904 on the attribute tree explorer window 900 include the same functions as described above with reference to the decision tree explorer window. However, an attribute tree explorer button 910 as shown in FIG. 9B opens a nested attribute tree explorer window. In embodiments of the invention, right-clicking an attribute tree within the attribute tree explorer window can also access the nested attribute tree explorer window.

FIG. 10 is a screen shot illustrating a Boolean explorer window 100 in accordance with an embodiment of the invention. The Boolean explorer window 100 allows users to view a Boolean attribute 104 identified by a name 102 and a description 103, without having to know the full path based upon segments and inbound events. In order to open the Boolean explorer window 100, a user may click on the Boolean attribute within the decision tree explorer window, attribute tree explorer window, or credit decision navigator tree viewer. As another option, a user may right-click on the Boolean attribute within the decision tree explorer window, attribute tree explorer window or credit decision navigator tree viewer. The utilization frames including the decision tree utilization 106 and the attribute tree utilization 108 both function as described above with reference to the credit navigator window.

FIG. 11 is a screen shot illustrating a computed explorer window 110 in accordance with an embodiment of the invention, in which a computed attribute is identified by a name at 112 and a description 113. The computed explorer window 110 allows users to view computed attribute details 114 without having to view a full path based upon segments and inbound events. The computed explorer window 110 may be opened by selecting a computed explorer button on the tool bar of the decision tree explorer window, attribute tree explorer window, or credit decision navigator tree viewer. Alternatively, a user may open the computed explorer window 110 by right clicking on the computed attribute within the decision tree explorer window, attribute tree explorer window, or credit decision navigator window. The utilization frames including decision tree utilization frame 116 and attribute tree utilization frame 118 both function identically to those disclosed in connection with the credit decision navigator window.

FIG. 12A is a screen shot illustrating an external attribute explorer window 120 in accordance with an embodiment of the invention. The external attribute tree explorer window 120 allows users to view external attribute details without having to view a full path based upon segments and inbound events. The external attribute tree explorer window 120 may be opened by right clicking on the external attribute within the decision tree explorer window, attribute tree explorer window, or credit decision navigator tree viewer. Alternatively, the external attribute tree explorer window 120 may be opened by selecting the external attribute explorer button on the tool bar on the decision tree explorer window, attribute tree explorer window, or credit decision navigator tree viewer. Information regarding external attributes 121, such as description 122, data type 123, decimals 124, signed 125, constant 126, offset 127, length 128, spool file field 129, ADS table 119, and ADS field 117 is provided in the identified columns for each external attribute.

FIG. 12B is a screen shot illustrating a process of exporting attribute data implementing an export attribute data option 115 in accordance with an embodiment of the invention. Upon selecting to export, a save screen 111 may be displayed.

FIG. 13 is a screen shot illustrating a matrix explorer window 130 in accordance with an embodiment of the invention. The matrix explorer window 130 allows users to view matrix details without having to view the full path based upon segments and inbound events. The matrix explorer window 130 can be opened by right clicking on the matrix attribute within the decision tree explorer window, attribute tree explorer window, or credit decision navigator tree viewer. The matrix explorer window 130 can also be opened by selecting the matrix explorer button on the tool bar on the decision tree explorer, attribute tree explorer window or credit decision navigator tree viewer. The selected matrix 132 can be exported to MSExcel® using an export button 134.

FIG. 14 is a screen shot illustrating an outbound event explorer window 140 in accordance with an embodiment of the invention. The outbound event list explorer window 140 allows users to view outbound event list details without knowledge of the full path based upon segments and inbound events. The outbound event list explorer window 140 can be opened by right clicking on an outbound event list within the credit decision navigator tree viewer 330 or by clicking the outbound event list explorer button on the credit decision navigator window. An outbound event list is a layout for a text string. The string of text is created based upon a layout 142 for a text string. The layout 142 may include start column 141 and length column 143 that correspond to a position in the text string for each item of the outbound event list. The string of text may further include either text value 144 or attribute 145 in each entry. The text string ultimately may be output by the decision engine 50. In the displayed outbound event explorer window 140, an outbound event CLAJOMAT 148 is displayed. As illustrated, CLAJOMAT 148 includes two outbound events, CLAJOMAT 146 and RTE2STAT 147.

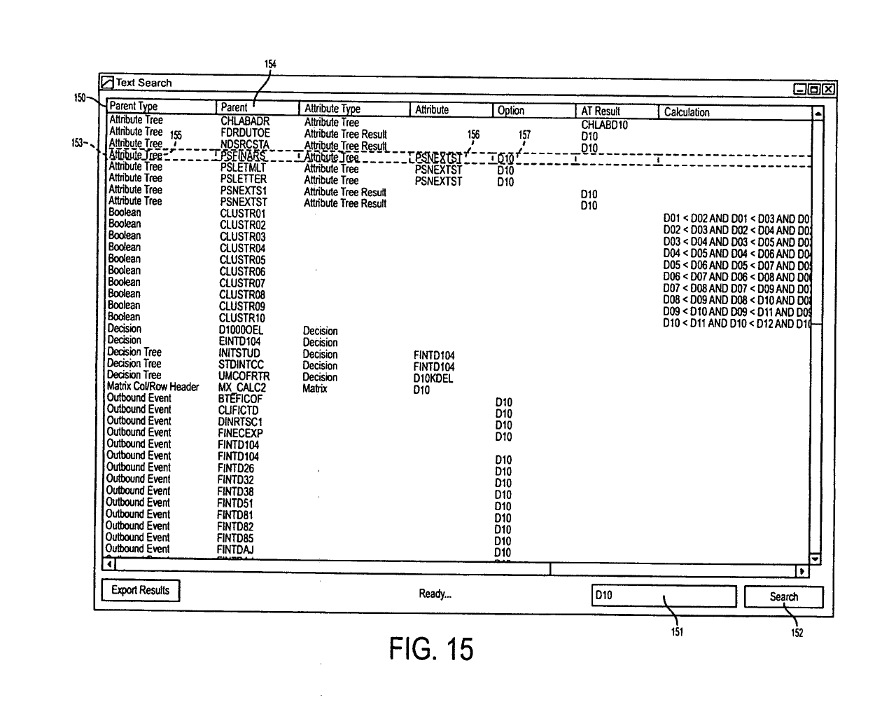

FIG. 15 is a screen shot illustrating a text search window 150 in accordance with an embodiment of the invention. The text search window 150 allows users to search the decision engine databases for any text matching an entered value. To complete a text search, the user need only enter a value in a textbox 151 and select the enter key or search button 152. The text search may be completed on multiple items including: attribute tree routing options; attribute tree nodes; attribute tree results; decision tree routing options; decision tree nodes; function names; matrix column and row headers; matrix column and row ranges; outbound event list names; outbound event list attributes; and outbound event list text values. Results of the text search appear in table format, which allows the display of parent attributes 154. In the illustrated example, highlighted item 153 includes a parent name PSFINARS, which is a parent type attribute tree 155. Within PSFINARS, an attribute tree exists named PSNEXTST 156. This attribute tree has an option entitled D10 157

FIG. 16 is a screen shot illustrating a bookmarks window 160 in accordance with an embodiment of the invention. The bookmarks window 160 can be opened by selecting the bookmarks menu, selecting “item” and “go to” from the drop down list. Bookmarks may be used in the credit decision navigator to store positions in the credit decision navigator tree control. These stored positions allow users to easily return to a saved location using the bookmarks window 160. When the bookmarks window 160 appears, a list is generated displaying the user's bookmarks 161 followed by all other bookmarks 162. This feature allows users to easily access their own bookmarks or share bookmarks with others. A saved bookmark can be activated by double clicking on a selected bookmark or selecting a bookmark and clicking a goto button 163. As illustrated, bookmarks can be created and deleted using buttons 164 and 165. After a bookmark is created, the credit decision navigator tree viewer automatically expands all nodes within the bookmark's saved tree path and selects the bookmarked node.

FIG. 17A is a screen shot illustrating a simulation results explorer window 170 in accordance with an embodiment of the invention. The simulation results explorer window allows users to view simulation results in a visual interface. Users can access the simulation results explorer window 170 by selecting the simulation results explorer button on the credit decision navigator window. After a simulation run is complete and test details have been captured, results can be loaded into the simulation results explorer window 170 by selecting a select results file button 171. Once the simulation results file is loaded, a test scenario drop down menu 172 populates as shown in FIG. 17B. A search button 173 enables searching for text in a selected test scenario.

FIG. 17C is a screen shot illustrating a populated simulation results viewer 174 in accordance with an embodiment of the invention upon selection of test scenario 175 and entry of text 176 and activation of the search button 173. FIG. 17D is a screen shot illustrating another view of the simulation results viewer 170 in accordance with an embodiment of the invention. Once display processing is selected, a visual representation of the test results is displayed at 177.

FIG. 18A is a screen shot illustrating a nested attribute and RANDNUM check window 180 in accordance with an embodiment of the invention. The window 180 allows users to view the attribute trees that are nested and also verifies that that the external attribute randnum is within an acceptable range. Users can access the window 180 by selecting the nested attribute and randnum check option under the menu item queries on the credit decision navigator window. FIG. 18B is a screen shot illustrating export of the nested attribute list in accordance with an embodiment of the invention by activation of an export attribute list button 181. FIG. 18C is a screen shot illustrating export of a random number list by activation of an export randnum list button 182 in accordance with an embodiment of the invention.

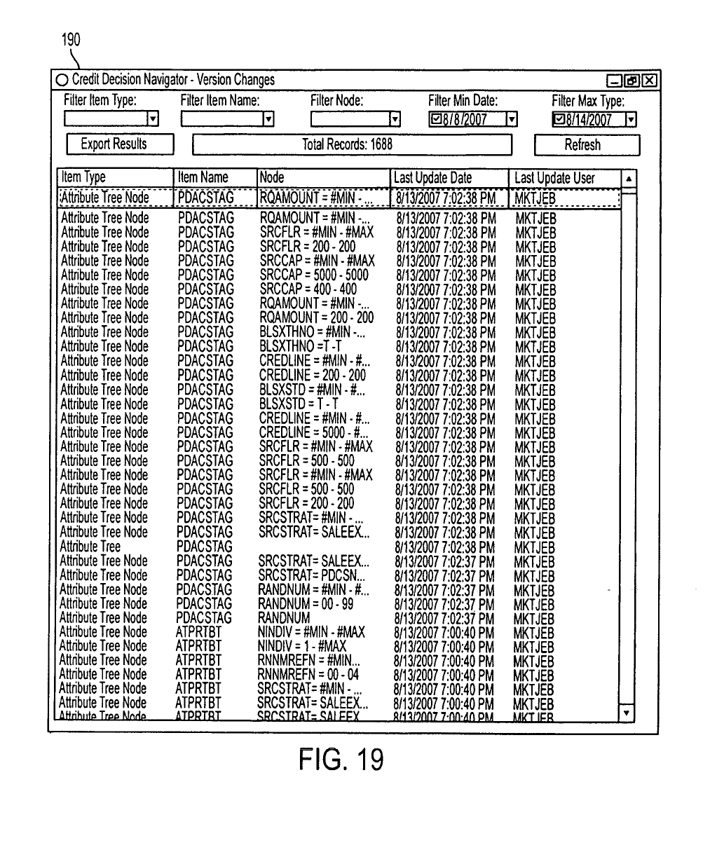

FIG. 19 is a screen shot illustrating a credit decision navigator version change window 190 in accordance with an embodiment of the invention. The version change window 190 allows users to view the changes that are made by the credit decision engine 50. Users can access the version changes window 190 by selecting the version changes option under the menu item queries on the credit decision navigator window.

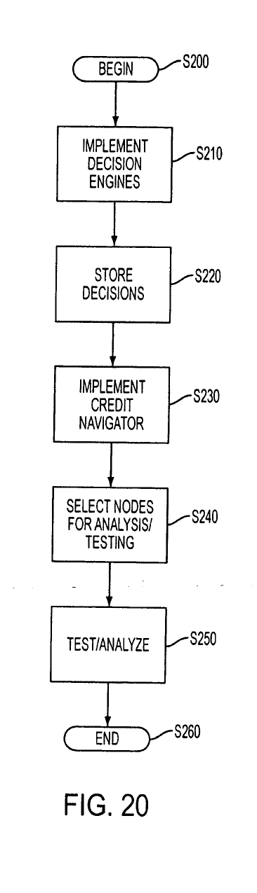

FIG. 20 illustrates a method of implementing the decisioning computing system in accordance with an embodiment of the invention. The method begins in S200 and the system implements the decision engine in S210. In S220, the system stores decisions made by the decision engine. In S230, when prompted by a business user, the system implements the credit navigator. In S240, the business user selects nodes for testing and analysis. In S250, the business user is able to test and analyze decision processes implementing the selected node using the credit navigator. The method ends in S260. Many other methods of using the described credit navigator are also possible.

While particular embodiments of the invention have been illustrated and described in detail herein, it should be understood that various changes and modifications might be made to the invention without departing from the scope and intent of the invention.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

1. A computer-implemented credit navigation system for navigating through functions implemented by a credit decision engine, the credit navigation system comprising:
a decision viewer application for installation on a user computing device;
a computer memory stored at the decision viewer;
at least one interactive user interface for accepting input, the interface enabling the input including selection of at least one of a segment selected from multiple selectable segments, an inbound event selected from multiple selectable inbound events, and a node selected from multiple selectable nodes;
computer processing components receiving the input and accessing and executing the decision viewer application for operating:
a decision engine for making credit related decisions based on two or more business rules and available data, wherein the two or more business rules are simultaneously viewable, and wherein the data is from databases configured to provide answers to multidimensional queries; and
a credit decision navigation engine implementing a main navigator module for displaying a separate credit decision navigator window, the credit decision navigator window comprising:
a credit navigator tree viewer for displaying a listing of multiple decision trees including selectable nodes related to the at least one selected segment and at least one selected inbound event, wherein the selectable nodes include decision functions performed by the decision engine for the at least one selected segment and the at least one selected inbound event, the credit navigator tree viewer providing a visual emphasis on a selected node;
a selectable and expandable tree path viewing pane for viewing a full path of the selected node on the credit navigator tree viewer;
a selectable decision tree utilization viewing pane for displaying a list of all decision trees using the selected node on the credit navigator tree viewer, wherein the credit navigator tree viewer, the tree path viewing pane and the decision tree utilization viewing pane are simultaneously viewable;
a bookmark engine to store one or more positions in the credit navigator tree viewer, wherein the bookmark engine can be activated to automatically expand all selected nodes within a bookmark's saved tree path;
wherein the credit related decision made by the decision engine activates the decision viewer application to display the credit navigation engine and allow a user to navigate the credit navigation engine; and
wherein the credit related decision creates low-volume testing documentation.

2. (canceled)

3. (canceled)

4. The credit navigation system of claim 1, wherein the credit decision navigator window comprises an attribute tree utilization pane for displaying a list of all attribute trees that use the selected node on the credit navigator tree viewer.

5. The credit navigation system of claim 1, further comprising a decision tree explorer toolbar button on the credit decision navigator window for generating a decision tree explorer window enabling a user to view individual decision trees without viewing a full segment and inbound event path.

6. The credit navigation system of claim 5, further comprising a search tree option within the decision tree explorer window for opening a tree search results window.

7. The credit navigation system of claim 1, further comprising an attribute tree explorer toolbar button on the credit decision navigator window for generating an attribute tree explorer window for allowing viewing of attribute trees without a full segment and inbound event path.

8. The credit navigation system of claim 7, further comprising an attribute tree explorer button on the attribute tree explorer window that opens a nested attribute tree explorer window.

9. The credit navigation system of claim 1, further comprising a Boolean explorer window enabling viewing of a Boolean attribute without a full path based on segment and inbound event.

10. The credit navigation system of claim 1, further comprising a matrix explorer window enabling viewing of matrix details without a full path based on segment and inbound event.

11. The credit navigation system of claim 1, further comprising a data exportation option.

12-22. (canceled)

23. A computer-implemented method for managing credit related decisions reached through the use of a decision engine, the decision engine implementing multiple businesses rules and available data to arrive at the credit related decisions, the method comprising;
providing a user a decision viewer application for installation on a user computing device;
storing computer programs and decisions made through the use of the decision engine in a computer memory;
accessing the decision viewer application from the computer memory and executing the computer program using computer processing components to perform steps including:
accepting input through an interface, the interface enabling and the input including selection of at least one of a segment from multiple selectable segments, an inbound event from multiple selectable events, and a node from multiple selectable nodes;
displaying the credit related decisions made by the decision engine implementing a credit decision navigation engine for facilitating viewing of the credit related decisions, the credit decision navigation engine generating a credit navigator tree viewer for displaying the selectable nodes related to the at least one selected segment and the at least one selected inbound event, wherein the selectable nodes include decision functions performed for the at least one selected segment and the at least one selected inbound event to arrive at the credit related decisions;
processing selection of a selectable node from the credit navigator tree viewer and providing a visible emphasis on the selected node on the credit navigator tree viewer; and
displaying additional data related to the selected node, wherein the additional data is displayed on:
a tree path viewing pane for displaying a full path of the selected node on the credit navigator tree viewer, and
a decision tree utilization viewing pane for displaying all decision trees that utilize the selected node on the credit navigator tree viewer, wherein the credit navigator tree viewer, the tree path viewing pane and the decision tree utilization viewing pane are simultaneously viewable; and
storing, using a bookmark engine, one or more positions in the credit navigator tree, wherein the bookmark engine can be activated to automatically expand all selected nodes within a bookmark's saved tree path;
wherein the credit related decision made by the decision engine activates the decision viewer application to display the credit navigation engine and allow a user to navigate the credit navigation engine;
wherein the credit related decision creates low-volume testing documentation;
wherein the multiple business rules are simultaneously viewable, and wherein the data is from databases configured to provide answers to multidimensional queries.

24. (canceled)

25. (canceled)

26. The method of claim 23, further comprising displaying the additional data in an attribute tree utilization pane for displaying a list of all attribute trees that use the selected node on the credit navigator tree viewer.

27. The method of 23, further comprising implementing a decision tree explorer toolbar button for generating a decision tree explorer window enabling a user to view individual decision trees without viewing a full segment and inbound event path.

28. The method of claim 27, further comprising implementing a search tree option within the decision tree explorer window for opening a tree search results window.

29. The method of claim 23, further comprising implementing an attribute tree explorer toolbar button for generating an attribute tree explorer window for allowing viewing of attribute trees without a full segment and inbound event path.

30. The credit navigation system of claim 23, further comprising implementing an attribute tree explorer button on the attribute tree explorer window that opens a nested attribute tree explorer window.

31. A credit navigation system for navigating through functions implemented by a credit decision engine, the credit navigation system comprising:
a decision viewer application for installation on a user computing device;
a computer memory storing at the decision viewer application;
at least one interactive user interface for accepting input, the input including at least one of a segment selection from multiple selectable segments and an inbound event from multiple selectable inbound events;
computer processing components receiving the input and accessing and executing the decision viewer application for operating a decision navigation engine, the decision navigation engine implementing a main navigator module for displaying a credit decision navigator window, the credit decision navigator window comprising:
multiple simultaneously viewable panes including;
a credit navigator tree viewer for displaying selectable nodes related to at least one selected segment and at least one selected inbound event, wherein the selectable nodes include decision functions performed by the decision engine for the at least one selected segment and the at least one selected inbound event, the credit navigator tree viewer providing a visual emphasis on a selected node;
a tree path viewing pane for displaying a full path of the selected node on the credit navigator tree viewer;
a decision tree utilization viewing pane for displaying all decision trees that utilize the selected node on the credit navigator tree viewer;
an attribute tree utilization pane for displaying a list of all attribute trees that use the selected node on the credit navigator tree viewer; and
a bookmark engine to store one or more positions in the credit navigator tree viewer, wherein the bookmark engine can be activated to automatically expand all selected nodes within a bookmark's saved tree path; and
multiple simultaneously viewable toolbar buttons including:
a decision tree explorer toolbar button for generating a decision tree explorer window enabling a user to view individual decision trees without viewing a full segment and inbound event path; and
an attribute tree explorer toolbar button on the credit decision navigator window for generating an attribute tree explorer window for allowing viewing of attribute trees without a full segment and inbound event path; and
a bookmark toolbar to activate the bookmark engine to automatically expand all selected nodes within a bookmark's saved tree path;
wherein the credit related decision made by the decision engine activates the decision viewer application to display the credit navigation engine and allow a user to navigate the credit navigation engine;
wherein the credit related decision creates low-volume testing documentation.
